(19) United States
(12) Patent Application Publication
(10) Pub. No.: US 2026/0049029 A1
(43) Pub. Date: Feb. 19, 2026

(54) BRICK AND MANUFACTURTING METHOD THEREFOR

(71) Applicant: Sung Man HAN, Ansan-si (KR)

(72) Inventor: Sung Man HAN, Ansan-si (KR)

(21) Appl. No.: 19/103,546

(22) PCT Filed: Aug. 22, 2023
(86) PCT No.: PCT/KR2023/012363

§ 371 Date: Feb. 12, 2025

(30) Foreign Application Priority Data
Aug. 29, 2022 (KR) 10-2022-0108319

(51) Int. Cl. C04B 14/10; B28B 3/04; B28B 3/22; B28B 11/16; C04B 7/02; C04B 22/12; C04B 22/14; C04B 24/06; C04B 28/26

(52) U.S. Cl. CPC C04B 14/10; B28B 3/04; B28B 3/22; B28B 11/16; C04B 7/02; C04B 22/12; C04B 22/14; C04B 24/06; C04B 28/26; C04B 2201/52

(57) ABSTRACT

The present invention relates to a brick and a manufacturing method therefor, and provides a brick which has at least improved strength by comprising: as a brick material, soil (e.g., red clay, clay, kaolin, and/or dredged soil), sludge or the like used as a base material; and a solidifying agent for solidifying the base material, and a manufacturing method therefor. According to the present invention, particles of the base material constituting the brick are firmly gathered together, resulting in at least improved strength.

### TECHNICAL FIELD

The present invention relates to a brick and a manufacturing method therefor, and more particularly, to a brick using soil (e.g., red clay, clay, kaolin, and/or dredged soil), sludge or the like, as a brick material, and including a solidifying agent that solidifies the base material to improve at least strength, and a manufacturing method therefor, and a brick manufacturing apparatus capable of manufacturing a high-strength brick through a continuous extrusion process.

### BACKGROUND ART

Bricks are widely used in building walls. Some fire-bricks are used in construction of boilers, furnaces, electric furnaces, and nuclear reactors. In general, bricks are manufactured using sand, cement, soil (for example, red clay, clay, and kaolin), or the like as materials. Recently, soil bricks mainly made of red clay or clay as a main ingredient are preferred.

In addition, in terms of recycling of resources, techniques using sludge, dredged soil, or the like as a main ingredient have been proposed. For example, Korean Patent No. 10-0949932 proposes a method of manufacturing lightweight bricks using sludge generated from sewage/wastewater facilities, and Korean Patent No. 10-1002547 proposes clay bricks made from recycled dredged soil and sludge and a method for manufacturing the same. However, conventional soil bricks (made of red clay or clay) and recycled bricks (made of sludge or dredged soil) have a problem in that the strength decreases due to a weak cohesion between material particles that form the bricks.

On the other hand, bricks may be divided into a pressurization type and an extrusion type according to their manufacturing methods.

The pressurization method is performed by putting brick materials into a mold of a specific shape and performing pressurization (pressing) through a hydraulic press. The pressurization method may produce bricks with high strength (compressive strength, etc.), but its productivity is relatively low compared to the extrusion method. For example, Korean Patent No. 10-1302069 and Korean Utility Model No. 20-0228809 suggest a pressurization-type brick manufacturing apparatus.

The extrusion method is performed by putting brick materials into an extruder (which may be referred to as a pug mill) to perform continuously extrusion and cutting a molded product to a certain size. The extrusion method has an advantage of relatively high productivity due to the continuous process compared to the pressurization method. Specifically, in the extrusion method, a viscous brick material (for example, dough such as red clay or clay) is put into the extruder equipped with a feed screw, the material is extruded by an operation of the feed screw while passing through an extrusion part (or mold) having a specific shape to form a molded product, and then, the molded product is cut by a cutter to continuously manufacture bricks with a certain shape. In this case, the extrusion part (or mold) has a smaller size than that of a main body of the extruder, and the shape and size (thickness and width) of the brick are determined by the size of the extrusion part (or mold). For example, Korean Patent No. 10-0298634, Korean Patent No. 10-1131687, and Korean Patent No. 10-1743180 discloses an extrusion-type brick manufacturing apparatus.

However, although such an extrusion-type brick manufacturing method has higher productivity than the pressurization method, it has the disadvantage of a low tissue density (density of material particles) of the brick. Accordingly, the strength of the brick is weak, and in some cases, there is a problem that distortion occurs during a drying process.

In addition, in some cases, bricks should be larger than a general size depending on the purpose of use and application, but in the related art methods, the size of the brick is determined (restricted) by an inner diameter (size) of the extrusion part (or mold). In other words, in the conventional brick manufacturing techniques, it is difficult to expand the inner diameter of the extrusion part (or mold) to a larger size, and thus, the brick size (width or thickness) is limited to the inner diameter of the extrusion part (or mold).

### DISCLOSURE

### Technical Problem

Therefore, the present invention has been made in view of the above problems, and it is an object of the present invention to provide a brick in which particles of materials that form the brick are firmly aggregated (bonded) to provide improved strength, and a manufacturing method therefor.

It is another object of the present invention to provide a brick manufacturing method and a brick manufacturing apparatus capable of manufacturing high-strength (high-density) bricks with dense tissues by a continuous extrusion process.

It is still another object of the present invention to provide a brick manufacturing method and a brick manufacturing apparatus capable of manufacturing large-size bricks with dense tissues using an expansion mold.

### Technical Solution

In accordance with an aspect of the present invention,
the above and other objects can be accomplished by the provision of a brick including a base material, and
a solidifying agent that solidifies the base material.

In accordance with another aspect of the present invention,
there is provided a brick manufacturing method including
mixing a brick material, and
molding the mixed brick material,
in which the brick material includes
a base material and a solidifying agent.

In accordance with a further aspect of the present invention,
there is provided a brick manufacturing method including mixing a brick material,
extruding the mixed brick material to form a molded body, and cutting the molded body,
in which the brick material includes
a base material and
a solidifying agent that solidifies the base material.

The solidifying agent may include sodium silicate (Na2SiO3), sodium chloride (NaCl), potassium chloride (KCl), calcium chloride (CaCl2)), sodium sulfate (Na2SO4), and citric acid.

Further, the base material may include one or more of soil and sludge. The soil may correspond to red clay, clay, kaolin, dredged soil, and the like.

In accordance with a still further aspect of the present invention,
there is provided a brick manufacturing apparatus including an extruder that extrudes a brick material and includes an extruder body in which a feed screw is provided, and an extrusion part formed on one side of the extruder body,
a mold that is supplied with an extruded object extruded from the extrusion part and forms the extruded object into a molded body, a load unit that applies a load to the extruded object supplied from the extrusion part to the mold to increase a density of the extruded object, and a cutter that cuts the molded body discharged from the mold.

The mold may be provided as an expansion mold that forms the extruded object into the molded body having a transverse section (cross-section perpendicular to an extrusion direction) larger than that of the extruded object extruded from the extrusion part.

Further, the expansion mold may include an expansion part that is connected to the extrusion part, and an expansion molding part that is formed on one side of the expansion part and forms the molded body having the transverse section (cross-section perpendicular to the extrusion direction) larger than that of the extruded object.

In addition, the load unit may include a baffle plate to which the extruded object is attached, and a load member that supports the baffle plate, and applies a load to the baffle plate.

The load unit may further include an elevating member that moves the load member vertically.

### Advantageous Effects

According to the present invention, since particles of base materials that form a brick are firmly aggregated by a solidifying agent, it is possible to manufacture a brick with improved strength. In addition, it is possible to manufacture a high-strength (high-density) brick with dense tissues by a continuous extrusion process. Furthermore, it is possible to manufacture a large-size brick with dense tissues using an expansion mold.

### DESCRIPTION OF DRAWINGS

FIG. 1 is a side view of a brick manufacturing apparatus according to an embodiment of the present disclosure;

FIG. 2 is a side view of main parts of the brick manufacturing apparatus according to the embodiment of the present disclosure;

FIG. 3 is a plan view of main parts of the brick manufacturing apparatus according to the embodiment of the present disclosure;

FIG. 4 is a side view of main parts of the brick manufacturing apparatus according to the embodiment of the present disclosure, showing an operation process of the brick manufacturing apparatus (a state where a load unit is provided in a molding line);

FIG. 5 is a side view of main parts of the brick manufacturing apparatus according to the embodiment of the present disclosure, showing an operation process of the brick manufacturing apparatus (a state where the load unit is removed from the molding line);

FIG. 6 is a plan view of main parts of the brick manufacturing apparatus according to the embodiment of the present disclosure, showing a state where the load unit is provided); and

FIG. 7 is a diagram showing a comparison example with reference to the present disclosure, which is a plan view showing a case where a load unit is not provided.

### MODE FOR INVENTION

The term “and/or” as used in the present specification is used to include one or more of components listed before and after. The terms “first”, “second”, “one side”, and “other side” are used to distinguish one component from another, and each component is not limited by these terms.

According to a first embodiment of the present invention, there is provided a brick in which particles of materials that form the brick are firmly aggregated (bonded) to provide improved strength. According to a second embodiment of the present invention, there is provided a brick manufacturing method for manufacturing a high-strength brick. According to a third embodiment of the present invention, there is provided a brick manufacturing apparatus for manufacturing a brick with dense tissues (high strength/high density) through a continuous extrusion process. According to a fourth embodiment of the present invention, there is provided a brick manufactured by the brick manufacturing apparatus according to the present invention. In addition, according to a fifth embodiment of the present invention, there is provided a brick manufacturing method using the brick manufacturing apparatus according to the present invention, and a brick manufactured by the same.

The brick according to the present invention includes a base material and a solidifying agent that solidifies the base material. That is, the brick includes the base material and the solidifying agent as main brick materials that form the brick. The brick according to the present invention is not particularly limited, but for example, may be manufactured by a pressurization type (injection molding) method and/or an extrusion type (extrusion molding) method, for example.

The brick may be a molded body made of the base material and the solidifying agent. In the present description, the size (width×thickness×length) and shape of the brick are not particularly limited, and the brick may have various sizes and shapes. In addition, the brick may have the same size and/or shape as in an ordinary brick. Further, the brick may include a block larger than the size of the ordinary brick, a panel or a board that is slightly flat and has a wider area (width×length) than the ordinary brick, or a bar that is longer than the length of the ordinary brick.

The brick manufacturing method may include a step of mixing brick materials and a step of molding the mixed brick materials. Here, the molding step may use a pressurization type (injection molding) and/or an extrusion molding type, for example. Further, the brick manufacturing method may include a step of mixing brick materials, a step of extruding the mixed brick materials to form a molded body, and a step of cutting the molded body. In the brick manufacturing method, the brick materials include a base material and a solidifying agent that solidifies the base material.

Hereinafter, embodiments of the brick manufacturing apparatus, the brick, and the brick manufacturing method according to the present invention will be described with reference to the accompanying drawings. The drawings are provided for illustration of exemplary embodiments of the present invention, and for the purpose of understanding the invention. In the drawings, the thickness may be exaggerated to express each layer and area clearly, and the scope of the invention is not limited by the thickness, size, and ratio indicated in the drawings. In addition, in describing the embodiments of the present invention, a detailed description of the related known function and/or configuration will be omitted.

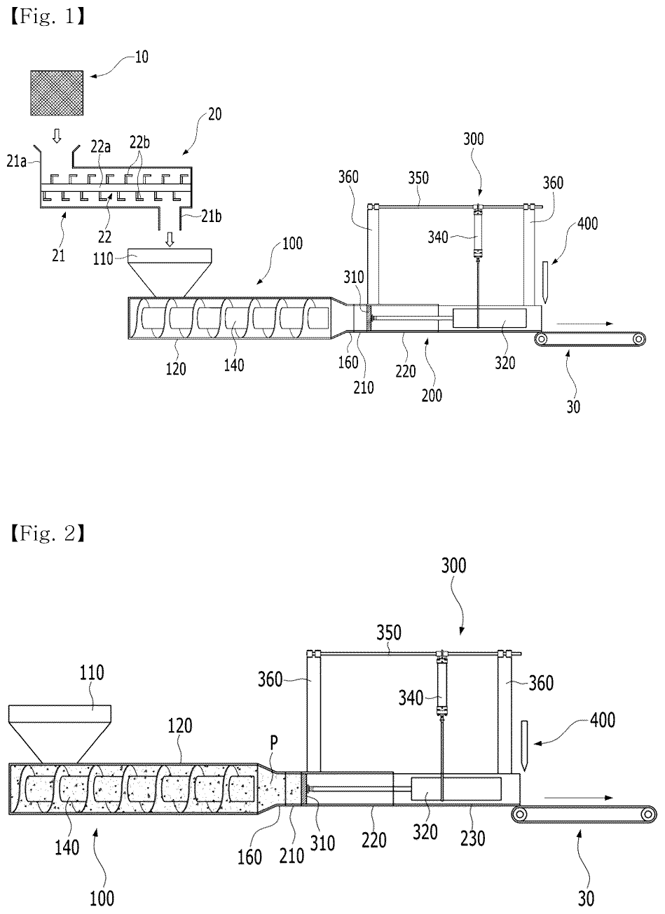

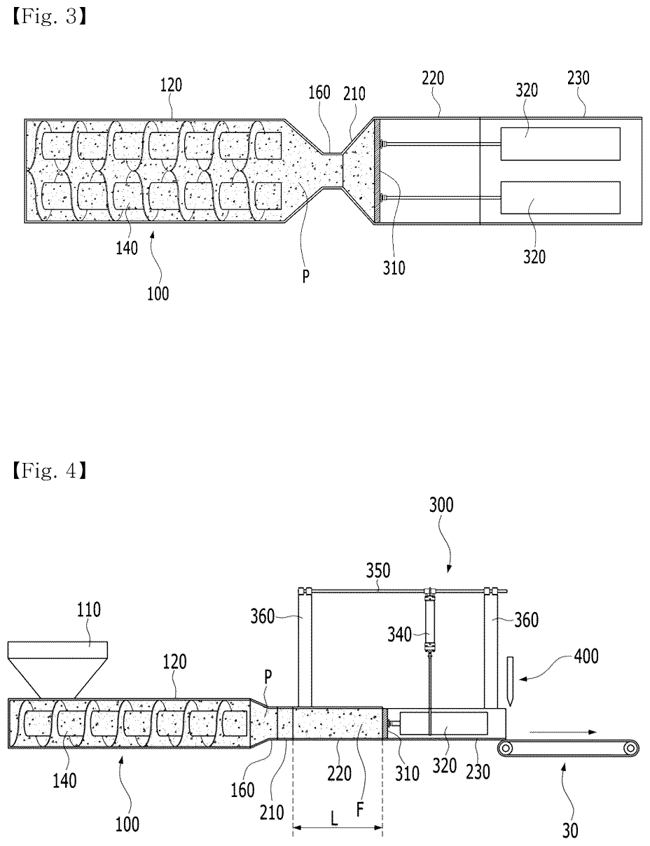

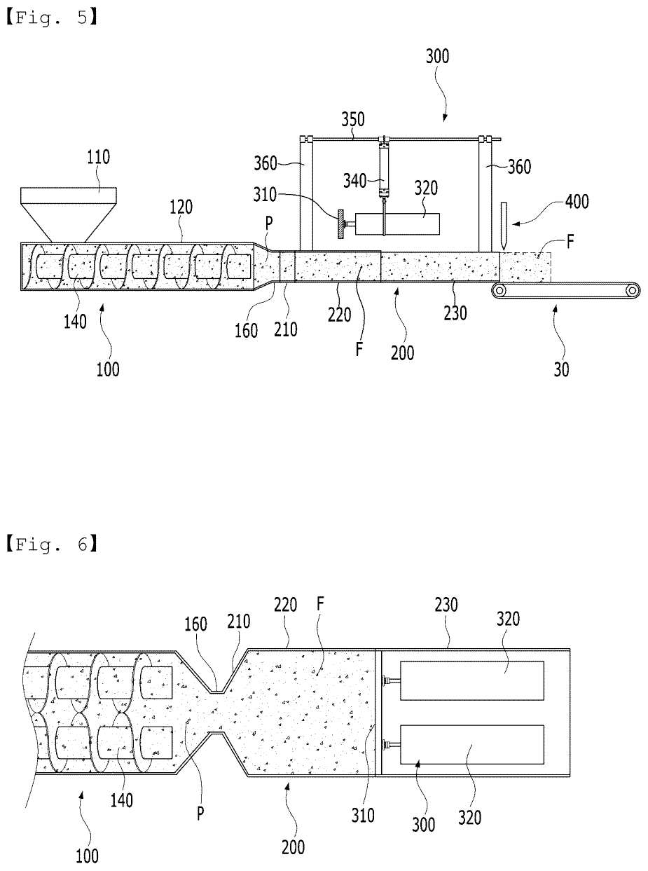

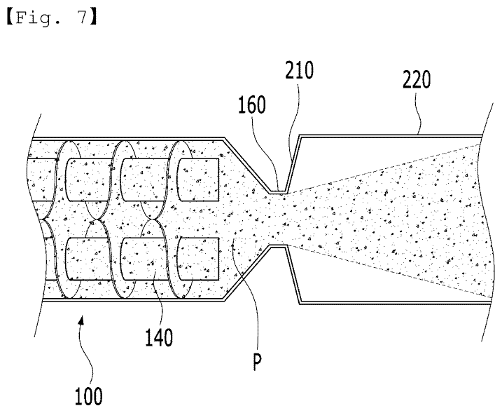

FIG. 1 is a side view of a brick manufacturing apparatus according to an embodiment of the present disclosure, FIG. 2 is a side view of main parts of the brick manufacturing apparatus according to the embodiment of the present disclosure, and FIG. 3 is a plan view of main parts of the brick manufacturing apparatus according to the embodiment of the present disclosure. FIG. 4 and FIG. 5 are side views of main parts of the brick manufacturing apparatus according to the embodiment of the present disclosure, showing an operation process of the brick manufacturing apparatus. In addition, FIG. 6 is a plan view of main parts of the brick manufacturing apparatus according to the embodiment of the present disclosure, showing a state where a load unit is provided, and FIG. 7 is a diagram showing a comparison example with reference to the present disclosure (FIG. 6), which shows a case where a load unit is not provided.

A brick manufacturing apparatus according to an embodiment of the present invention includes an extruder 100 that extrudes brick materials toward a mold 200, the mold 200 that receives an extruded object (P) extruded from the extruder 100 and forms the product into a molded body (F), a load unit 300 that applies a load to the extruded object (P) to increase a density of the extruded object (P), and a cutter 400 that cuts the molded body (F) discharged from the mold 200. The brick manufacturing apparatus according to the present embodiment may further include a mixer 20 (for example, a kneader) for mixing brick materials, and/or a feed conveyor 30 for conveying the molded body (F). Hereinafter, an example of the respective components will be described.

First, in the present embodiment, the brick materials include a base material and a solidifying agent.

The base material is not particularly limited as long as it can be used as a material for bricks. The base material may be selected from a variety of materials such as sand, cement, soil and sludge. According to the present embodiment, the base material may include one or more of the above-mentioned materials. The soil may be selected from, for example, red clay, clay, kaolin, and dredged soil.

In addition, the base material may further include one or more of illite, germanium, mica, elvan stone, jade, amethyst, and charcoal. The base material may include, for example, one or more of concrete (a mixture of sand and cement), soil (red clay, clay, kaolin, and/or dredged soil), and sludge as main ingredients, and may further include one or more of illite, germanium, mica, elvan stone, jade, amethyst, and charcoal as additional ingredients. The dredged soil is immersed in or around the bottom of rivers, streams, reservoirs, and coastal areas, which may be dried and crushed after collection for use. The sludge may be selected from sludge of a water purification plant, sludge of a sewage and wastewater treatment plant, paper sludge and/or sludge of an excreta treatment plant. The sludge may include, for example, an inorganic sludge with an inorganic content of 40% by weight or more among solids. For example, the sludge may be provided by dehydrating, drying, and crushing the sludge of the water purification plant.

As described above, the brick materials may include one or more base materials selected from particles such as soil (red clay, clay, kaolin and/or dredged soil, etc.) and sludge, and the solidifying agent that solidifies the base materials. In this case, the base material may have an average particle size (D50) of 20 to 1,000 mesh, for example, and more specifically, an average particle size (D50) of 50 to 500 mesh. Such base materials may occupy, for example, 70 to 98% by weight, 75 to 96% by weight, or 80 to 95% by weight in a total weight of the brick materials (in terms of solid content).

The solidifying agent may function to aggregate (bind) particles of the base materials. The particles of the base materials are solidly aggregated (bonded) by the solidifying agent, to thereby resulting in a solid brick with improved strength. Such a solidifying agent may occupy, for example, 0.1 to 12% by weight, 0.2 to 10% by weight, or 0.5 to 8% by weight in the total weight of the brick materials (in terms of solid content).

According to the present embodiment, the solidifying agent may include sodium silicate (Na2SiO3), sodium chloride (NaCl), potassium chloride (KCl), calcium chloride (CaCl2)), sodium sulfate (Na2SO4), and citric acid. The solidifying agent may preferably include 100 parts by weight of sodium silicate (Na2SiO3), 10 to 30 parts by weight of sodium chloride (NaCl), 15 to 40 parts by weight of potassium chloride (KCl), 10 to 30 parts by weight of calcium chloride (CaCl2)), 2 to 8 parts by weight of sodium sulfate (Na2SO4), and 1 to 6 parts by weight of citric acid. The soldering agent including these ingredients and contents firmly solidifies the particles of the base material such as red clay to prevent smearing of the base material in a case where it comes into contact with a human body, and effectively improve the surface hardness and strength (compressive strength, tensile strength, fracture strength, and bending strength, etc.) of the brick. The brick according to the present embodiment may have a compressive strength of 32 MPa or higher, for example, or a compressive strength of 35 MPa or higher by using the above-mentioned solidifying agent.

In addition, the solidifying agent may include sodium silicate (Na2SiO3), sodium chloride (NaCl), potassium chloride (KCl), calcium chloride (CaCl2)), sodium sulfate (Na2SO4), and citric acid as main ingredients, and may further include an additive.

The additive is not particularly limited and may be selected from, for example, a small amount of cobalt (Co) compound, phosphorus (P) compound, barium (BA) compound, magnesium (Mg) compound, aluminum (Al) compound, silicon (Si) compound, fluorine (F) compound, iron (Fe) compound, lignin sulfonates, and/or basic compound (NaOH, etc.). The additive may occupy 0.005 to 2 parts by weight, respectively, in 100 parts by weight of sodium silicate (Na2SiO3), for example.

According to the present embodiment, the brick materials may include the above-mentioned base material and solidifying agent as main ingredients, and may further include a reinforcement material for strength reinforcement. The reinforcement material may be selected from a fiber material and/or cement, etc. The fiber material may include a pulverized material such as pulp, fabric and/or non-woven fabric. In addition, the brick materials may, in some cases, further include an adequate amount of water for dough and/or a colored material (pigment) for color implementation.

As a specific example, the brick materials may include one or more base materials of soil (red clay, clay, kaolin, and/or dredged soil), sludge and the like, a solidifying agent that solidifies the base material, and cement for reinforcement of the bonding strength. Here, the brick material may include, for example, 75 to 96% by weight of the base material, 0.2 to 10% by weight of the solidifying agent, and 2 to 15% by weight of the cement.

Referring to FIG. 1, the brick manufacturing apparatus according to the present embodiment may further include a material sorter 10 for sorting brick materials for homogeneity of the above-mentioned brick materials, and/or a crusher (not shown) for crushing the brick materials. The material sorter 10 and the crusher may be provided at the rear of the extruder 100. The material sorter 10 screens (sifts) stones or foreign substances contained in soil such as red clay or dredged soil for removal, and may include, for example, a screen net capable of selecting materials of uniform particles. For example, in a case where soil such as red clay, clay and/or dredged soil is used as the base material of the brick, stones or foreign substances contained in the soil may be removed using the material sorter 10, the soil may be crushed using the crusher such as a roll crusher, and then uniform and fine particles may be obtained through a sieve.

The brick materials are supplied to the extruder 100. The brick materials including the base material and the solidifying agent as main ingredients are supplied with a suitable amount of water and mixed therewith so as to have a viscosity suitable for being extruded by the extruder 100. The mixture of the brick materials and the water for the suitable viscosity may be obtained by the extruder 100 in this way, but, may be obtained by a separate mixer 20 and then supplied to the extruder 100. To this end, the brick manufacturing apparatus according to the present embodiment may further include the mixer 20 provided at the rear of the extruder 100.

The mixer 20 mixes the brick materials and the water to produce viscous dough. For example, the mixer 20 may be a kneader. Referring to FIG. 1, the mixer 20 performs kneading while advancing the brick materials, and may be configured to have one or more kneaders 22 provided in a housing 21. The kneader 22 includes a rotating shaft 22a and a plurality of kneading blades 22b formed around the rotating shaft 22a. In a case where the brick materials are supplied to an inlet 21a of the housing 21, the kneading blades 22b are rotated by rotation of the rotating shaft 22a, and the brick materials are kneaded by the rotation of the kneading blades 22b and discharged toward an outlet 21b. Here, the base materials (e.g., soil particles of red clay, clay, kaolin and/or dredged soil) and a solution of the solidifying agent as the brick materials may be separately supplied to the inlet 21a of the housing 21. The solidifying solution may be obtained by dissolving the above-described solidifying agent in water.

The extruder 100 extrudes the brick materials into the mold 200, which may employ a known extruder. The extruder 100 includes an extruder body 120 that forms an internal space, a feed screw 140 provided inside the extruder body 120, and an extrusion part 160 provided on one side (right side in the drawing) of the extruder body 120. In addition, a hopper 110 to be supplied with the brick materials may be provided on the other side (left side in the drawing) of the extruder body 120. One or more feed screws 140 may be provided inside the extruder body 120, and a twin-screw extruder 100 with two feed screws 140 (see FIG. 3) is shown in the drawing, for example.

According to the present embodiment, the extrusion part 160 may be integrally formed on one side of the extruder body 120, which may have an inner diameter (size) smaller than that of the extruder body 120 for dense brick tissues. In other words, the extrusion part 160 with reduced transverse section (inner diameter) in an extrusion direction (right direction in the drawing) may be formed on one side of the extruder body 120.

In the present description, the “transverse section” refers to a cross-section perpendicular to the extrusion direction (arrow direction in the drawing). In addition, in the present description, the “inner diameter” and “size” refer to one or more lengths selected from horizontal and vertical lengths at the transverse section (cross-section perpendicular to the extrusion direction).

The brick materials supplied to the extruder body 120 through the hopper 110 is fed and extruded through the extrusion part 160 toward the mold 200 by the rotation of the feed screw 140. In this case, the extruded object (P) passes through the extrusion part 160 with a smaller inner diameter (transverse section) than that of the extruder body 120 to have dense tissues (increased density of the brick materials). The extruded object (P) from the extrusion part 160 is fed into the mold 200.

The mold 200 is supplied with the extruded object (P) from the extrusion part 160 and molds the extruded object (P) into a specific molded body (F). The extruded object (P) formed by the extrusion part 160 and the molded body (F) formed by the mold 200 may have the same transverse section (size), or the molded body (F) formed by the mold 200 may have a transverse section (size) larger than that of the extruded object (P) formed by the extrusion part 160. In the latter case, the mold 200 may be provided as an expansion mold. Accordingly, the expansion mold 200 forms the molded body (F) having a transverse section larger than that of the extruded object (P) extruded from the extrusion part 160.

The expansion mold 200 includes an expansion part 210 (see FIG. 3) whose inner diameter (transverse section) is gradually expanded in the extrusion direction (right direction in the drawing) and an expansion molding part 220 formed on one side of the expansion part (right side in the drawing). Here, the expansion part 210 is connected to the extrusion part 160 and is supplied with the extruded object (P) extruded from the extrusion part 160. The expansion molding part 220 has an inner diameter (transverse section) larger than that of the extrusion part 160 in its entire length range (L) (see FIG. 4), which forms the molded body (F) with a transverse section (size) larger than that of the extruded object (P). The expansion molding part 220 may have, for example, a transverse section shape such as a rectangle or square. In addition, in the expansion part 210, an air outlet hole (not shown) from which air is discharged may be formed. The air outlet hole may be formed as a plurality of holes in the expansion part 210, which allows air to be discharged outside when the extruded object (P) is introduced, thereby improving the density of the brick tissues (minimizing the air pores).

The expansion mold 200 may be fixedly coupled to the extrusion part 160 to form an integrated structure. Alternatively, the expansion mold 200 may be detachably coupled to the extrusion part 160. The expansion mold 200 may be detachably coupled to the extrusion part 160 through a joint member such as a flange. In this case, since the expansion mold 200 is replaced by another expansion mold having a different inner diameter (transverse section) as necessary (that is, the expansion molding part 220 is replaced by another expansion molding part having a different inner diameter (transverse section)), it is possible to manufacture bricks of various sizes (transverse sections).

According to the present embodiment, the expansion mold 200 may further include a guide 230 formed on one side (right side in the drawing) of the expansion molding part 220. The guide 230 is integrally extended on one side (right side in the drawing) of the expansion molding part 220, which may have a structure with an open upper part. Specifically, the expansion mold 200 may have a cross-sectional shape of approximately “Q” in the expansion part 210 and the expansion molding part 220, and may have a cross-sectional shape of approximately “U”, which is opened upward in the guide 230. The guide part 230 provides an installation space of the load unit 300 at the beginning of brick manufacturing (when the initial extruded object (P) is introduced), and guides the molded body (F) that is discharged from the expansion molding part 220 after the removal of the load unit 300.

The load unit 300 applies a load to the extruded object (P) supplied from the extrusion part 160 to the mold 200, thereby increasing the density (g/cm3, weight per unit volume) of the extruded object (P). Specifically, the brick material particles (for example, base material particles such as red clay, clay, kaolin and/or dredged soil) forming the extruded object (P) are concentrated in the mold 200 by the load unit 300, thereby increasing the density of the extruded object (P). Accordingly, it is possible to effectively provide brick tissues of high density and high strength. In addition, when forming the molded body (F) with the expanded transverse section (size) greater than that of the extruded object (P) using the expansion mold 200, the load unit 300 allows the extruded object (P) to be filled in the expansion mold 200, thereby improving the density of the expanded molded body (F).

According to the present embodiment, the load unit 300 includes a baffle plate 310 to which the extruded object (P) is attached, and a load member 320 that supports the baffle plate 310 and apply load to the baffle plate 310.

The baffle plate 310 is provided in the mold 200. Specifically, the baffle plate 310 is provided in the expansion molding part 220 and moves horizontally in the length range (L) of the expansion molding part 220 (see FIG. 4). The baffle plate 310 suppresses the extruded object (P) from easily passing through the expansion molding part 220 to increase the density of the extruded object (P). Specifically, the baffle plate 310 interferes with a forward force (extrusion force) that allows the extruded object (P) passed through the expansion part 210 to pass through the expansion molding part 220, to thereby fill the extruded object (P) in the expansion part 210 and the expansion molding part 220, thereby increasing the tissue density of the extruded object (P).

The load member 320 is provided on one side (right side in the drawing) of the baffle plate 310, which supports the baffle plate 310 and applies a load to the baffle plate 310. Here, the load member 320 may preferably apply a load (resistance) for preventing the baffle plate 310 from being pushed easily by the forward force (extrusion force) of the extruded object (P). Specifically, the load member 320 may apply a load force smaller than the forward force (extrusion power) of the extruded object (P) so that the extruded object (P) can slowly pass through the interior of the expansion molding part 220 in a state where the extruded object (P) is in close contact with the baffle plate 310. As an example, the load member 320 may employ an elastic member capable of applying a load while resiliently supporting the baffle plate 310. As another example, the load member 320 may employ an actuator capable of applying a load to the baffle plate 310 through an energy source such as electricity, hydraulic pressure and/or compressed air. According to the present embodiment, preferably, the load member 320 may be an actuator such as a hydraulic cylinder or a pneumatic cylinder. In addition, one or more load members 320 may be provided on one side of the baffle plate 310. As shown in the drawing, the load member 320 may be an actuator (for example, hydraulic cylinder), and may be provided in the internal space of the guide 230.

According to the present embodiment, the load unit 300 may further include an elevating member 340 that moves the load member 320 vertically. In addition, the load unit 300 may further include a rail 350 that moves the elevating member 340 horizontally. Further, the load unit 300 may further include a support member 360 that supports the rail 350 and/or the elevating member 340.

The elevating member 340 is provided above the load member 320. Here, one end part (lower part in the drawing) of the elevating member 340 may be connected to the load member 320, and the other end part (upper part in the drawing) may be connected to the rail 350. The elevating member 340 may be an actuator such as a hydraulic cylinder or a pneumatic cylinder. In addition, the rail 350 is provided above the elevating member 340. Here, the rail 350 may have a structure that allows the elevating member 340 to move horizontally. Thus, the elevating member 340 moves horizontally along the rail 350.

Accordingly, the load unit 300 may move vertically and horizontally by the elevating member 340 and the rail 350. In other words, the baffle plate 310 and the load member 320 may move vertically and horizontally by the elevating member 340 and the rail 350. The baffle plate 310 and the load member 320 may be detached from the mold 200 by the above-mentioned vertical and horizontal movement. FIG. 5 shows a state where the baffle plate 310 and the load member 320 are placed above the mold 200 after being detached from the mold 200.

A process of manufacturing bricks using the brick manufacturing apparatus will be described.

Referring to FIGS. 1 to 3, the brick materials are put into the extruder 100 and extruded. As described above, the brick materials may be sufficiently kneaded through the kneader 20 and then put into the extruder 100. The extrusion part 160 produces the extruded object (P) by extrusion and discharges the extruded object (P) in the extrusion direction (arrow direction in the drawing). The extruded object (P) is supplied to the expansion part 210 of the expansion mold 200. In this case, the load unit 300 is provided in the expansion mold 200, as shown in FIGS. 1 to 3. Here, the baffle plate 310 is provided on one side of the expansion molding part 220. More specifically, the baffle plate 310 is located at the border between the expansion part 210 and the expansion molding part 220 inside the expansion molding part 220. In addition, the load member 320 is provided in the guide 230.

Referring to FIG. 4, in a case where the extruded object (P) is continuously fed into the expansion mold 200, the extruded object (P) is filled up inside the expansion part 210, and the baffle plate 310 moves slowly by the forward force (extrusion force) of the extruded object (P). The baffle plate 310 moves in the extrusion direction (right side in the drawing) in the length range (L) of the expansion molding part 220, and is located at the end of the expansion molding part 220, i.e., at the border between the expansion molding part 220 and the guide 230. Thus, inside the expansion molding part 220, the extruded object (P) passed through the expansion part 210 is formed into the molded body (F) with dense tissues.

Referring to FIG. 5, in a case where the baffle plate 310 is located at the end of the expansion molding part 220, the load unit 300 is removed from the molding line (extrusion line). In other words, the baffle plate 310 and the load member 320 are detached from the expansion mold 200. Here, as described above, the baffle plate 310 and the load member 320 moves upward and then moves to the left by the elevating member 340 and the rail 350 to be removed from the expansion mold 200. As shown in FIG. 5, the baffle plate 310 and the load member 320 may be located above the expansion mold 200 after being removed from the molding line (extrusion line) of the expansion mold 200. Even after the load unit 300 is detached from the molding line (extrusion line), the extruded object (P) continues to be fed into the expansion molding part 220, so that the molded body (F) is continuously produced while being pushed in the extrusion direction. The molded body (F) passes through the expansion molding part 220, is discharged toward along the guide 230, and then is supplied to the cutter 400 on the feed conveyor 30.

After the load unit 300 is detached, in a case where the extruded object (P) is continuously introduced into the expansion molding part 220, the extruded object (P) becomes dense by friction with an internal wall of the expansion molding part 220. In other words, after the load unit 300 is detached, the friction force with respect to the internal wall of the expansion molding part 220 acts as a load, so that the extruded object (P) or the molded body (F) can have dense tissues by the wall friction (load). To this end, the length (L) of the expansion molding part 220 (see FIG. 4) may have a length of 30 cm or longer. As a specific example, the length (L) of the extension molding part 220 may have a length of 30 cm to 2 m or 40 cm to 1.5 m.

According to the present embodiment, the load unit 300 may further include a sensor (not shown) that detects the position of the baffle plate 310 and a control unit (not shown) that operates (controls) at least the elevating member 340 according to a sensing signal of the sensor. Here, the sensor may be provided at the end of the expansion molding part 220, that is, at the boundary between the expansion molding part 220 and the guide 230, and may transmit a signal to the control unit when the baffle plate 310 reaches the boundary. In addition, the control unit may operate the elevating member 340 so that the baffle plate 310 and the load member 320 can be detached from the molding line (extrusion line).

The cutter 400 is provided at the end of the expansion mold 200 in the direction of extrusion (right side in the drawing), and cuts the molded body discharged from the mold 200 in a certain length. The cutter 400 may be used as a known cutter. The cutter 400 may have a cutting part such as a blade, saw tooth or wire.

On the bottom side of the cutter 400, the feed conveyor 30 may be provided. The molded body of a certain length cut by the cutter 400 is continuously transported through the feed conveyor 30. Subsequently, the molded body transported by the transfer conveyor 30 may be dried to form the brick. The plurality of molded bodies may be dried together in a state of being stacked on a tray. In this case, the molded body may be naturally dried and/or hot-air dried, and may be fired at high temperature in a heating furnace, as necessary.

After manufacturing a certain amount of bricks through the extrusion, molding, cutting, and drying as described above, the manufacturing process is repeated by returning the load unit 300 to its original position. For example, after completing the amount of bricks to be manufactured or the amount of brick materials to be used for a day, the manufacturing process is repeated by placing the baffle plate 310 and the load member 320 of the load unit 300 into the molding line (extrusion line).

According to the above-described manufacturing apparatus of the present invention, it is possible to manufacture bricks by the continuous extrusion process, and to manufacture bricks with high strength (density) and dense tissues using the load unit 300. In addition, it is possible to manufacture bricks having dense tissues and a transverse section (size) larger than that of the extrusion part 160 using the load unit 300 and the expansion mold 200.

Referring to FIG. 6, in the present embodiment, the load unit 300 increase the density (particle tissue density) by applying a load to the extruded object (P), and fills the expansion part 210 and the expansion molding part 220 with the extruded object (P), to thereby manufacture the molded body (F) having a transverse section (size) larger than that of the extrusion part 160. FIG. 7 is a diagram showing a comparison example with reference to FIG. 6. In a case where no load unit 300 is provided as in FIG. 7, the extruded object (P) easily moves forward in the extrusion direction. In this case, the expansion part 210 and the expansion molding part 220 are not sufficiently filled with the extruded object (P), thereby making it difficult to form the molded body (F), and to provide a high density (particle tissue density).

On the other hand, the brick manufacturing apparatus according to the present embodiment may further include a mobile means that can move the above-mentioned components 100, 200, 300, and 400 in a state where the components 100, 200, 300, and 400 are placed on the mobile means. The mobile means may be a transportation means such as a trailer. Generally, a large trailer is equipped with a hydraulic power pack, through which the necessary hydraulic pressure may be supplied from the actuator (hydraulic cylinder) that forms the load member 320 or the elevating member 340 of the load unit 300.

The mobile means (trailer or the like) may be equipped with the above-mentioned extruder 100, expansion mold 200, load unit 300, and cutter 400, and in some cases, may be equipped with the material sorter 10, the mixer 20, the crusher and/or feed conveyor 30, and the like.

In a case where the brick manufacturing apparatus according to the present embodiment further includes the above-mentioned mobile means, the brick manufacturing apparatus may move to, for example, a construction site of a building (a wall of the building) to directly manufacture bricks at the construction site. In addition, the brick manufacturing apparatus according to the present embodiment may move to a site for collecting brick materials such as red clay, clay, kaolin and/or dredged soil to directly manufacture the bricks at the site. In this case, it is possible to reduce the transportation and storage costs of the brick materials, thereby lowering the unit price of the bricks.

Hereinafter, examples of the present invention and comparison examples are exemplified. The following examples and comparison examples show brick manufacturing examples, specifically, experimental examples according to the ingredients and contents of the solidifying agent. The following examples are merely examples for ease of understanding of the invention, and do not limit the technical scope of the invention. In addition, the comparison examples do not mean a prior art, but are provided only for comparison with the examples.

### Example 1

Well-dried red clay powder with an average particle size of about 350 mesh was prepared, and then, mixed powder was obtained by mixing typical Portland cement and the prepared red clay power. Further, a solidifying solution was obtained by mixing a solidifying agent with water. Subsequently, the mixed powder and the solidifying solution were mixed to obtain dough, and then, the dough was put into a mold to produce a molded brick of about 60 mm×60 mm×180 mm (width×thickness×length). Here, the dough includes about 88% by weight of red clay power, about 9.6% by weigh of cement, and about 2.4% by weight of the solidifying agent in terms of solid content. In addition, the solidifying agent includes 100 parts by weight of sodium silicate (Na2SiO3), about 14 parts by weight of sodium chloride (NaCl), about 26 parts by weight of potassium chloride (KCl), about 16 parts by weight of calcium chloride (CaCl2)), about 4 parts by weight of sodium sulfate (Na2SO4), and about 3 parts by weight of citric acid.

The molded brick was cured at room temperature for three days to obtain a brick specimen, the compressive strength and the degree of smearing of the brick were evaluated. Evaluation results are shown in [Table 1]. The compressive strength was measured using a typical compressive strength tester. The degree of smearing was measured by rubbing the brick specimen several times with a finger. Here, in a case where the red clay was found on the finger, the result was denoted as “Yes”, and in a case where the red clay was rarely found on the finger, the result was denoted as “No”.

### Comparison Example 1 and 2

Brick specimens were manufactured for respective comparison examples by performing the same operation as in Example 1, except that the ingredients and contents of the solidifying agents were changed. The ingredients and contents of the solidifying agents used in the respective comparison examples are shown in [Table 1]. In addition, the compressive strength and the degree of smearing were evaluated in the same way as in Example 1 for the brick specimen (after 3 days of curing) formed according to the respective comparison examples, and results thereof were shown in [Table 1].

TABLE 1
<Evaluation results of characteristics of brick specimens according to ingredients
and contents of solidifying agents, Unit: Parts by Weight>

| | | | Comparison | Comparison |
|---|---|---|---|---|
| | | Example 1 | example 1 | example 2 |
| Ingredients | Sodium silicate (Na₂SiO₃) | 100 | 100 | 100 |
| and contents | Sodium Chloride (NaCl) | 18 | — | 36 |
| of solidifying | Potassium Chloride (KCl) | 26 | 12 | — |
| agent | Calcium Chloride (CaCl₂) | 16 | 35 | — |
| | Sodium sulfate (Na₂SO₄) | 4 | — | 10 |
| | Citric acid | 3 | — | 12 |
| | Sodium carbonate (Na₂CO₃) | — | 20 | — |
| | Calcium Carbonate (CaCO₃) | — | — | 20 |
| Characteristic | Compressive strength | 36.4 MPa | 30.2 MPa | 26.8 MPa |
| evaluation | Smearing | No | Yes | No |
| result | | | | |

As shown in [Table 1], it was seen that the characteristics of the brick specimens vary depending on the ingredients and contents of the solidifying agent. According to the experiments, in a case where the solidifying agent includes the ingredients and contents as in Example 1, the brick specimen has high strength (high compressive strength of about 36 MPa or higher) compared to the other cases (Comparison example 1 and 2), which also shows that the smearing of red clay does not occur.

### INDUSTRIAL APPLICABILITY

As is apparent from the above description, the present invention provides a brick having improved strength and accordingly is useful for a variety of industrial applications. In addition, according to the invention, it is possible to manufacture high-strength (high-density) bricks by a continuous extrusion process to thereby improving productivity, and to manufacture large-size bricks using an expansion mold.

1-12. (canceled)

13. A brick comprising:
a base material; and
a solidifying agent that solidifies the base material.

14. The brick according to claim 13, wherein the base material includes one or more of soil and sludge.

15. The brick according to claim 13, wherein the brick further includes a reinforcement material for strength reinforcement, and has a compressive strength of 32 MPa or higher,
wherein the base material includes one or more of red clay, clay, kaolin, dredged soil, and sludge, and
wherein the reinforcement material includes one or more of a fiber material and cement.

16. The brick according to claim 13, wherein the solidifying agent includes sodium silicate (Na2SiO3), sodium chloride (NaCl), potassium chloride (KCl), calcium chloride (CaCl2), sodium sulfate (Na2SO4), and citric acid.

17. The brick according to claim 16, wherein the solidifying agent includes 100 parts by weight of sodium silicate (Na2SiO3), 10 to 30 parts by weight of sodium chloride (NaCl), 15 to 40 parts by weight of potassium chloride (KCl), 10 to 30 parts by weight of calcium chloride (CaCl2), 2 to 8 parts by weight of sodium sulfate (Na2SO4), and 1 to 6 parts by weight of citric acid.

18. The brick according to claim 13, wherein the brick is manufactured by using a brick manufacturing apparatus, and has a compressive strength of 32 MPa or higher, wherein the brick manufacturing apparatus comprising:
an extruder that extrudes a brick material and includes an extruder body in which a feed screw is provided, and an extrusion part formed on one side of the extruder body;
a mold that is supplied with an extruded object extruded from the extrusion part and forms the extruded object into a molded body;
a load unit that applies a load to the extruded object supplied from the extrusion part to the mold to increase a density of the extruded object; and
a cutter that cuts the molded body discharged from the mold.

19. The brick according to claim 18, wherein the mold is provided as an expansion mold that forms the molded body having a transverse section (cross-section perpendicular to an extrusion direction) larger than that of the extruded object extruded from the extrusion part.

20. The brick according to claim 19, wherein the expansion mold includes an expansion part that is connected to the extrusion part; an expansion molding part that is formed on one side of the expansion part and forms the molded body having the transverse section larger than that of the extruded part; and a guide that is formed on one side of the expansion molding part,
wherein the load unit includes a baffle plate that is provided in the expansion molding part and to which the extruded object is attached; a load member that is provided in the guide, supports the baffle plate, and applies a load to the baffle plate; an elevating member that is provided above the load member and moves the load member vertically; and a rail that is provided above the elevating member to move the elevating member horizontally.

21. A brick manufacturing method comprising:
mixing a brick material; and
molding the mixed brick material,
wherein the brick material includes a base material, and a solidifying agent that solidifies the base material.

22. The method according to claim 21, wherein the solidifying agent includes sodium silicate (Na2SiO3), sodium chloride (NaCl), potassium chloride (KCl), calcium chloride (CaCl2), sodium sulfate (Na2SO4), and citric acid.

23. The method according to claim 21, wherein the brick manufacturing method is performed by using a brick manufacturing apparatus,
the brick manufacturing apparatus comprising:
an extruder that extrudes a brick material and includes an extruder body in which a feed screw is provided, and an extrusion part formed on one side of the extruder body;
a mold that is supplied with an extruded object extruded from the extrusion part and forms the extruded object into a molded body;
a load unit that applies a load to the extruded object supplied from the extrusion part to the mold to increase a density of the extruded object; and
a cutter that cuts the molded body discharged from the mold.

24. The method according to claim 23, wherein the mold is provided as an expansion mold that forms the molded body having a transverse section (cross-section perpendicular to an extrusion direction) larger than that of the extruded object extruded from the extrusion part.
